(19) United States
(12) Patent Application Publication
(10) Pub. No.: US 2002/0124448 A1
(43) Pub. Date: Sep. 12, 2002

(54) Reflective covering for signposts and the like

(76) Inventor: Daniel Seville, Washingtonville, NY (US)

Correspondence Address: Richard W. Goldstein, 2071 Clove Road, Staten Island, NY, 10304, US

(21) Appl. No.: 09/805,003

(22) Filed: Mar. 12, 2001

(51) Int. Cl. G09F 15/00

(52) U.S. Cl. 40/607

(57) ABSTRACT

A reflective covering for signposts and the like including a cover member adapted for securement to a signpost and the like. The cover member is comprised of a pliable panel adapted for conforming to the signpost and the like. The pliable panel has an inner surface and an outer surface. The inner surface is positionable against the signpost and the like. The outer surface includes a reflective coating disposed thereon.

### BACKGROUND OF THE INVENTION

The present invention relates to a reflective covering for signposts and the like and more particularly pertains to making signs and other roadside items more visible during poor visibility.

The problem with many roadside signs and other roadside items relates to visibility during inclement weather. When weather conditions worsen, such as in rain, fog, and snow, roadside signs are difficult to see. Poor weather conditions, combined with a night sky make seeing these roadside signs nearly impossible. What is needed is a simple device that will help to illuminate these signs by which a person traveling in a vehicle can notice the signs so that they can possibly read them.

The present invention attempts to solve the abovementioned problem by providing a device that can be simply attached to a signpost or other related support whereby a person in a vehicle can see these items during poor visibility.

The use of highway indicia devices is known in the prior art. More specifically, highway indicia devices heretofore devised and utilized for the purpose of improving visibility are known to consist basically of familiar, expected and obvious structural configurations, notwithstanding the myriad of designs encompassed by the crowded prior art that have been developed for the fulfillment of countless objectives and requirements.

By way of example, U.S. Pat. No. 5,759,671 to Tanaka discloses a luminescent sheet material capable of being used for road signs to improve visibility at night. U.S. Pat. No. 2,942,571 to White discloses a replacement cover for a highway marker that is conical in shape for fitting over a cone.

U.S. Pat. No. 5,873,187 to Kozak discloses the use of beads with fluorescent properties for use with road signs or pavement to improve visibility. U.S. Pat. No. 4,090,464 to Bishop discloses a clear plastic covering of a road sign, to prevent vandalism.

While these devices fulfill their respective, particular objective and requirements, the aforementioned patents do not describe a reflective covering for signposts and the like for making signs and other roadside items more visible during poor visibility.

In this respect, the reflective covering for signposts and the like according to the present invention substantially departs from the conventional concepts and designs of the prior art, and in doing so provides an apparatus primarily developed for the purpose of making signs and other roadside items more visible during poor visibility.

Therefore, it can be appreciated that there exists a continuing need for a new and improved reflective covering for signposts and the like which can be used for making signs and other roadside items more visible during poor visibility. In this regard, the present invention substantially fulfills this need.

### SUMMARY OF THE INVENTION

In the view of the foregoing disadvantages inherent in the known types of highway indicia devices now present in the prior art, the present invention provides an improved reflective covering for signposts and the like. As such, the general purpose of the present invention, which will be described subsequently in greater detail, is to provide a new and improved reflective covering for signposts and the like which has all the advantages of the prior art and none of the disadvantages.

To attain this, the present invention essentially comprises a cover member adapted for securement to a signpost and the like. The cover member comprises a pliable panel adapted for conforming to the signpost and the like. The pliable panel has an inner surface and an outer surface. The inner surface is positionable against the signpost and the like. The outer surface includes a reflective coating disposed thereon.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention

It is therefore an object of the present invention to provide a new and improved reflective covering for signposts and the like which has all the advantages of the prior art highway indicia devices and none of the disadvantages.

It is another object of the present invention to provide a new and improved reflective covering for signposts and the like which may be easily and efficiently manufactured and marketed.

It is a further object of the present invention to provide a new and improved reflective covering for signposts and the like which is of durable and reliable construction.

An even further object of the present invention is to provide a new and improved reflective covering for signposts and the like which is susceptible of a low cost of manufacture with regard to both materials and labor, and which accordingly is then susceptible of low prices of sale to the consuming public, thereby making such a reflective covering for signposts and the like economically available to the buying public.

Even still another object of the present invention is to provide a new and improved reflective covering for signposts and the like for making signs and other roadside items more visible during poor visibility.

Lastly, it is an object of the present invention to provide a new and improved reflective covering for signposts and the like including a cover member adapted for securement to a signpost and the like. The cover member comprises a pliable panel adapted for conforming to the signpost and the like. The pliable panel has an inner surface and an outer surface. The inner surface is positionable against the signpost and the like. The outer surface includes a reflective coating disposed thereon.

These together with other objects of the invention, along with the various features of novelty that characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of the preferred embodiment of the reflective covering for signposts and the like constructed in accordance with the principles of the present invention.

FIG. 1A is a cross-sectional view of the present invention as taken along line 1A-1A of FIG. 1.

FIG. 2 is a front view of the present invention as secured to a street sign.

FIG. 2A is a cross-sectional view of the present invention as taken along line 2A-2A of FIG. 2.

FIG. 3 is a perspective view of the present invention as secured to a guard rail.

FIG. 3A is a cross-sectional view of the present invention as taken along line 3A-3A of FIG. 3.

FIG. 4 is a perspective view of the present invention as secured to a highway divider.

FIG. 4A is a cross-sectional view of the present invention as taken along line 4A-4A of FIG. 4.

The same reference numerals refer to the same parts through the various figures.

### DESCRIPTION OF THE PREFERRED EMBODIMENT

With reference now to the drawings, and in particular, to figures one through four thereof, the preferred embodiment of the new and improved reflective covering for signposts and the like embodying the principles and concepts of the present invention and generally designated by the reference number 10 will be described.

Specifically, it will be noted in the various figures that the device relates to a reflective covering for signposts and the like for making signs and other roadside items more visible during poor visibility.

The present invention is essentially comprising a cover member 10. The cover member 10 is adapted for securement to a signpost 12 and the like. The cover member 10 is preferably constructed of a vinyl material. The cover member 10 comprises a pliable panel 14 adapted for conforming to the signpost 12 and the like. The pliable panel 14 has an inner surface and an outer surface. The inner surface is positionable against the signpost 12 and the like. The outer surface includes a reflective coating disposed thereon. The reflective coating can be impregnated into the outer surface, painted on, or stuck on, similar to reflective tape.

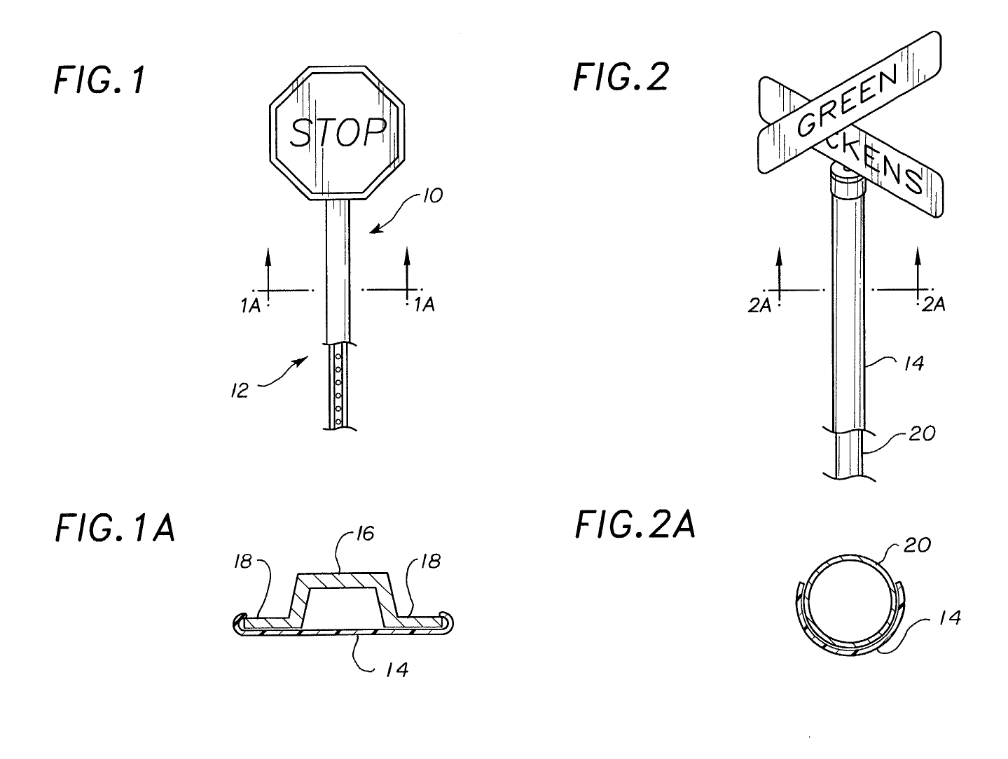

FIGS. 1 and 1A illustrate the present invention as secured to a roadside sign post. These posts 16 are hollow backed having tabs 18 extending outwardly from opposed side edges thereof. In this embodiment, the pliable panel 14 engages the tabs 18 while positioned on the front surface of the post 16.

FIGS. 2 and 2A illustrate the present invention as secured to a street sign post 20. In this design, the cover member 10 conforms to the street sign post 20 by forming a generally arcuate design.

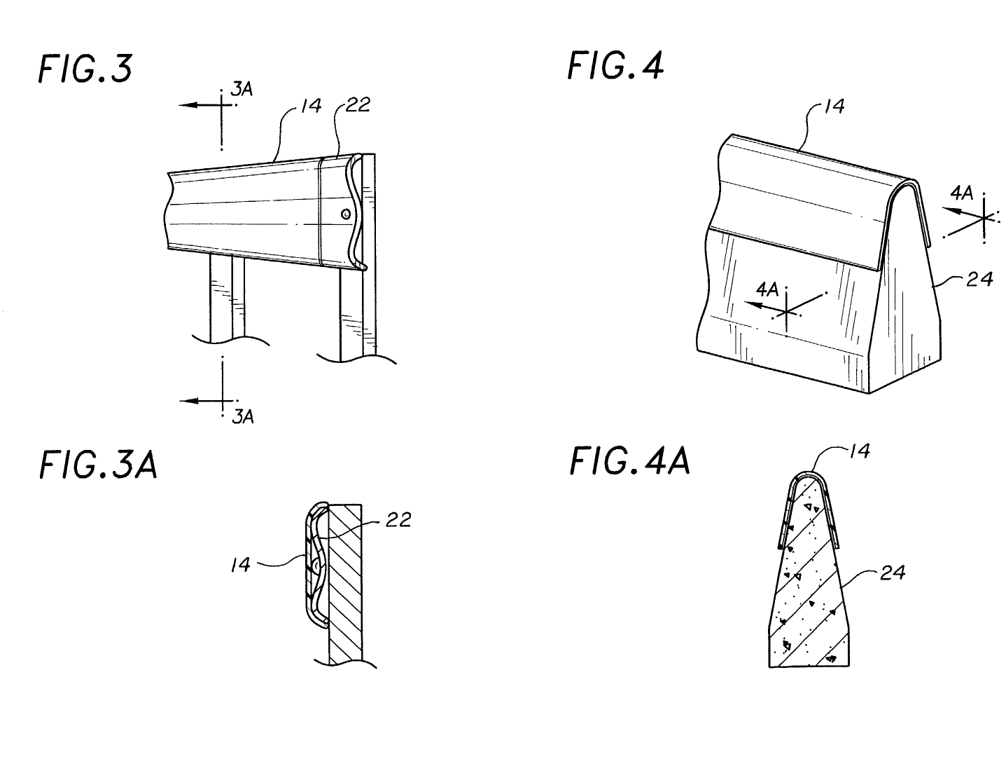

FIGS. 3 and 3A illustrate the present invention as secured to a guard rail 22. The pliable member 14 is simply wrapped around the front surface of the guard rail 22 to enhance it's visibility.

FIGS. 4 and 4A illustrate the present invention as secured to a highway divider 24. The pliable member 14 is positioned on top of the highway divider 24 so that vehicle travelers can easily visualize.

The present invention can also be designed for use on telephone poles, dock sidings, dock pilings, channel markers for marine navigation, light structures in parking lots, mail box posts, and the side rails on tractor trailers.

As to the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and the manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A reflective covering for signposts and the like for making signs and other roadside items more visible during poor visibility comprising, in combination:
a cover member adapted for securement to a signpost and the like, the cover member being comprised of a pliable panel adapted for conforming to the signpost and the like, the pliable panel having an inner surface and an outer surface, the inner surface being positionable against the signpost and the like, the outer surface including a reflective coating disposed thereon.

2. The reflective covering for signposts and the like as set forth in claim 1, wherein the cover member is adapted for securement to a street sign pole.

3. The reflective covering for signposts and the like as set forth in claim 1, wherein the cover member is adapted for securement to a guard rail.

4. The reflective covering for signposts and the like as set forth in claim 1, wherein the cover member is adapted for securement to a highway divider.
